(19) United States
(12) Patent Application Publication
(10) Pub. No.: US 2015/0332005 A1
(43) Pub. Date: Nov. 19, 2015

(54) METHOD OF INCREASING THE SUCCESS RATE OF ASSISTED REPRODUCTIVE TECHNOLOGY

(71) Applicant: Allison D. Meier, Houston, TX (US)

(72) Inventor: Allison D. Meier, Houston, TX (US)

(21) Appl. No.: 14/808,335

(22) Filed: Jul. 24, 2015

Related U.S. Application Data
(63) Continuation-in-part of application No. 13/858,000, filed on Apr. 6, 2013.

(51) Int. Cl. G06F 19/00; G06Q 40/08

(52) U.S. Cl. CPC G06F 19/345; G06Q 40/08

(57) ABSTRACT

It is estimated that 1 in 8 couples are affected by infertility. Many couples affected by infertility must go through Assisted Reproductive Technology (ART) to have a baby. Even with ART, only 30% of couples achieve live birth after one attempt and the average cost of one ART Cycle is $14,000, a cost that is large enough to cause significant stress, especially when the couple has no guarantee of success. The present invention therefore provides a computer-implemented method that identifies and actively changes the factors that decrease the likelihood of successful ART and specifically, reduces the stress factor by reimbursing some or all of the cost of unsuccessful ART Cycles.

### FIELD AND CROSS REFERENCE TO RELATED APPLICATION

The present application is a continuation-in-part of co-pending application Ser. No. 13/858,000, filed Apr. 6, 2013, and entitled ASSISTED REPRODUCTIVE TECHNOLOGY INSURANCE, the disclosure of which is hereby incorporated into this continuation-in-part application in its entirety by this specific reference. The disclosure of that prior application relates to certain insurance procedures, methodology and implementation, which compensate a policyholder for unsuccessful infertility services and Assisted Reproductive Technology (ART) procedures. The present application relates to a method of increasing the likelihood of successful ART by identifying and actively changing one or more of the several factors that influence ART success rate.

### BACKGROUND

Many women of childbearing age have problems conceiving a child. A 2002 national survey indicated that in the United States alone, there were 62 million women of reproductive age. That same year, 2% or 1.2 million women were reported to have had infertility related medical appointments within the previous year. An additional 10% were reported to have received infertility treatment at some time in their life.

The World Health Organization task force on Diagnosis and Treatment of Infertility determined in developed countries, diseases that contributed to infertility were attributed to the female partner in 37% of couples, to the male partner in 8% of couples, and to both partners in 35% of couples. Five percent of the couples had no identifiable cause of infertility (i.e., unexplained infertility).

The causes of female infertility most often identified include: ovulatory dysfunction, tubal factors, diminished ovarian reserve, endometriosis, uterine factors, unexplained factors, and other factors. One of those other factors, specifically stress, is a particularly important factor affecting the health of an individual undergoing an ART procedure, and of course a healthy woman is much more likely to carry a fetus to term, avoiding miscarriage and experience uncomplicated delivery. Decisions by people in the reproductive population to defer childbearing due to careers and other lifestyle factors are also increasing the numbers of infertile couples. The stress caused by and/or resulting from careers and lifestyle factors can also decrease the likelihood of successful ART.

Of course male infertility is also a factor in a couple's efforts to conceive. The most common causes of male infertility include abnormal sperm production or function, impaired delivery of sperm, general health and lifestyle issues, and overexposure to certain environmental elements. Sperm must be properly shaped and able to move rapidly and accurately toward the egg for fertilization to occur. If the shape and structure (morphology) of the sperm are abnormal or movement (motility) is impaired, sperm may not be able to reach or penetrate the egg. Normal sperm concentration is greater than or equal to 20 million sperm per milliliter of semen. A count of 10 million or fewer sperm per milliliter of semen indicates low sperm concentration (subfertility). A count of 40 million sperm or higher per milliliter of semen indicates increased fertility. Complete failure of the testicles to produce sperm is rare, affecting very few infertile men. A varicocele is a varicose vein in the scrotum that may prevent normal cooling of the testicle, leading to reduced sperm count and motility. Undescended testicle occurs when one or both testicles fail to descend from the abdomen into the scrotum during fetal development. Because the testicles are exposed to the higher internal body temperature, compared with the temperature in the scrotum, sperm production may be affected. Testosterone deficiency (male hypogonadism) infertility can result from disorders of the testicles themselves, or an abnormality affecting the hypothalamus or pituitary gland in the brain that produces the hormones that control the testicles. In the genetic defect Klinefelter's syndrome, a man has two X chromosomes and one Y chromosome instead of one X and one Y. This causes abnormal development of the testicles, resulting in low or absent sperm production and possibly low testosterone. Infection may temporarily affect sperm motility. Repeated bouts of sexually transmitted diseases (STDs) such as chlamydia and gonorrhea are often associated with male infertility. These infections can cause scarring and block sperm passage. If mumps, a viral infection usually affecting young children, occurs after puberty, inflammation of the testicles can impair sperm production. Inflammation of the prostate (prostatitis), urethra or epididymis also may alter sperm motility. Other factors in male infertility include sexual issues such as erectile dysfunction, retrograde ejaculation, anti-sperm antibodies, emotional stress, obesity, cancer, alcohol, and drug use/abuse.

Infertility services often include medical tests to diagnose infertility, medical advice and treatments, including artificial insemination, to help a woman become pregnant and services other than routine prenatal care to prevent miscarriage. ART includes all medical fertility treatments in which eggs are surgically removed from a woman's ovaries, then combining the eggs with sperm in a laboratory setting, and finally transferring the embryo back to the woman's uterus or donating them to another woman, but generally do not include therapy, counseling, or other active techniques for actively changing the many factors that influence the success rate of ART. Specifically, services for improving the health of the woman, improving prenatal care, and/or modifying the behavior of partners and/or a woman who abuses substance(s) are not provided, nor do such services identify and actively change, for instance by providing therapy and/or counseling, stress from lifestyle, employment, or other sources that may influence the outcome of ART on either the individual or the partners.

ART procedures performed in the United States have increased from approximately 85,000 in 1999 to approximately 150,000 in 2009 according to the Centers for Disease Control (CDC) Likewise, live births resulting from ART in 2009 were over two times higher than in 1999, with 31.4% of all procedures now performed resulting in a live birth. Of the various types of ART, approximately 99% of procedures in the United States are in vitro fertilization. Other types of ART include GIFT (gamete intrafallopian transfer) and ZIFT (zygote intrafallopian transfer), or a combination thereof.

Typically in an ART Cycle, a woman will take certain drugs such as clomiphene on day 1 through 10 of her cycle with egg retrieval on the tenth day. Once the eggs are retrieved they are combined with the sperm and the process of embryo formation occurs in the laboratory. The transferring of the embryos to the uterus occurs 3-5 days after the embryo starts to develop in the laboratory. Embryos can also be frozen and transferred at a later date to the women's uterus. Pregnancy will generally be achieved between day 23 and 27 with a live birth between approximately day 266 to day 276.

Factors influencing the success rate of ART include, but are not limited to: age, infertility diagnosis, history of previous births, previous miscarriages, previous ART procedures, number of embryos transferred, type of procedure, the clinic used, smoking use, drinking use, weight, and lifestyle and other stress factors.

In the United States, according to a Centers for Disease Control report from 2009, of all ART used, 39.9% of the procedures are performed on women under 35 years of age. 20.4% are performed on women between the ages of 35-37. 20.5% are performed on women ages 38-40. 9.8% are performed on women ages 41-42. 6% are performed on women ages 43-44 and 4.6% of the procedures are performed on women over 44 years of age. A woman's age is the most important factor affecting the chances of a live birth when her own eggs are used. Among women in their 20s, percentages of ART procedures resulting in pregnancies and live births were relatively stable; however percentages decline steadily from among women in their mid-30s onward.

In all age groups, women who had a previous live birth were more or equally likely to have a successful ART procedure and women who had had a previous miscarriage were about as likely to have a live birth from ART as women who had never been pregnant. However, in most age groups, percentages of ART procedures that resulted in live births were lower for women who had previously undergone unsuccessful ART procedures. Among women with previous births, percentages of ART Cycles that resulted in live births among women who did not undergo a previous ART Cycle were comparable to percentages among women who had undergone a previous ART Cycle.

45% of all women who underwent an ART Cycle in 2009 underwent one or more previous cycles. Thus, it is not uncommon for women to undergo multiple ART procedures.

Statistics that are available to aid in the underwriting process include, but are not limited to, the percentage of ART Cycles resulting in a live birth by age, infertility diagnosis, fresh versus frozen success rates, donor success rates, and clinic success rates.

Most health insurance programs do not pay for ART procedures. To date only 15 states require some form of coverage or notification of coverage for infertility. However, it is estimated that 94% of all traditional health insurance plans do not cover infertility treatments. The average cost of one in vitro fertilization treatment is over $8,000 in 2012 dollars. Broken down, the total average cost of one in vitro fertilization procedure, including testing and medications in 2012 dollars includes the following: 1) physician consult and testing $1500 to $3500, 2) treatment $8,158 for fresh or $3500 for frozen embryos, and 3) medications $2500 to $4000. Thus, the total average spent is roughly $12,000 to $18,000 which is not only a substantial sum, but if ART is unsuccessful, represents a total financial loss such that the cost constitutes a significant “gamble” on the part of the partners and/or individual.

On information and belief, no individual expense reimbursement insurance is currently available that provides partial or full financial reimbursement if no live birth is achieved from an ART Cycle. While there are programs that guarantee a live birth or the patient's money back, such programs are only contracted with select doctors, require an expensive upfront investment of all potential attempts paid in full, and do not cover costs of pre-screening, tests, medications, consultations, medical procedures, therapy and counseling, travel expenses, or a combination thereof.

It is, therefore, an object of the present invention to reduce the stress experienced by an individual undergoing an ART procedure as a way of increasing the likelihood of success of the ART procedure by providing an insurance or reimbursement policy to reimburse a policyholder for his/her financial investment in an ART procedure if no live birth is achieved that also allows for choice of doctor and reimbursement that includes costs of testing, medication, medical procedures, therapy and counseling, travel expenses, or a combination thereof. In more detail, it is an object of the present invention to provide a method for increasing the likelihood of successful ART procedures using computer technology and the Internet to implement a solution not previously known in the pre-Internet world and that goes beyond the creation or alteration of contractual relations using computer functions or conventional network operations by processing data that are both provided by the individual user and stored in the memory of a computer that subsequently performs mathematical and other operations programmed into the memory of the computer to transform that data into a product in the form of an infertility risk factor that is then used to calculate one or more premium prices for insuring against the cost of unsuccessful ART for purchase by the user thereby reducing the financial risk, and the stress incident to that financial risk, of ART.

The method of reducing stress by reducing the financial burden of ART described herein may be coupled with the identifying and active changing of other factors that influence the success of ART. For instance, the individual undergoing ART, or the partner of that individual, may be provided with counseling or testing that reveals a need for instruction and/or information as to their underlying emotional state, thought patterns, or beliefs that lead to actions and reactions that increase stress, anxiety, depression, overeating, fear, guilt and shame, all of which can decrease the success rate of pregnancy and live birth. Once thought pattern issues are identified, active steps are taken to provide reconditioning of thought patterns through, for instance, replacing destructive thought patterns with new healthy thought patterns. This active step can be accomplished through counseling, meditation, listening to calming music, exercising and other mind exercises. The individual may also be offered counseling on emotional changes often experienced during pregnancy, thereby providing the individual with an improved ability to understand and cope with those changes and providing additional stress relief, thereby increasing the likelihood of an uneventful, full-term pregnancy and delivery. Such counseling and other stress-reduction techniques may also be coupled with active therapies such as smoking cessation support and counseling, exercise programs, self-image and self-confidence counseling, and nutritional information and counseling, all for the purpose of increasing the likelihood of successful ART. Such counseling and stress reduction techniques are preferably delivered through the same interface utilized to deliver the insurance against cost for reducing the stress of the financial burden of ART and, as will be made clear from the following description, delivered in the same manner.

### SUMMARY

In one embodiment, the invention relates to a method of increasing the likelihood of successful ART by identifying and actively changing the factors that influence the success rate of ART, and specifically by reducing the stress caused by the expense of ART by generating an infertility risk factor product for an individual using a computer, the method comprising: a server hosting a web site, wherein the website contains a data entry interface, and wherein the website is connected by a network to a personal computer of an individual; and a server hosting a program, wherein the program comprises an actuarial algorithm.

In such embodiments, the method further entails the following: having the individual, using a personal computer, entering one or more infertility related conditions into a data entry interface that have been selected from a list of infertility related conditions which affect the infertility of the individual; transferring the infertility related conditions entered into the personal computer to a server hosting an actuarial algorithm; generating an infertility risk factor using the actuarial algorithm; using the infertility risk factor to generate one or more reimbursement options for ART and other infertility services with an insurance premium for each option; and outputting the reimbursement options and respective premium to the personal computer for selection of a reimbursement option and payment of the respective premium by the individual.

In further embodiments, a data entry interface is displayed on the personal computer that also includes a payment interface. In such embodiments the individual pays for the premium to activate the reimbursement option for an ART Cycle. Regarding payment, the payment is made through the payment interface to a website by an individual entering a credit card number, a debit card number or a bank account and routing number into the payment interface. Alternatively, the payment is sent to an operator of the servers by mail, in person or by courier.

In further embodiments, a server hosting the website and the server hosting the actuarial algorithm are the same server. Alternatively, the server hosting the website and the server hosting the algorithm are different servers. Alternatively, the server hosting the website is also used to deliver other stress-reduction services, that are specific to the individual, including counseling, information as to pregnancy and/or ART, lifestyle choices, and other factors that affect the outcome of ART.

In the embodiments of the invention relating to infertility, the infertility related condition or conditions is any infertility related condition or conditions. In more specific embodiments, the infertility related conditions include, but are not limited to: age of the individual, infertility diagnosis, body mass index of the individual, previous pregnancies by the individual, previous miscarriages by the individual, previous ART cycles by the individual and the results of those cycles, type of ART procedure, previous abortions, smoking use, drinking use, the clinic to be used for infertility treatment, whether the embryos will be fresh or frozen, whether donor eggs are used, male infertility factors, whether the individual's mother was given diethylstilbestrol during pregnancy, or a combination thereof.

In embodiments related to reimbursement of an ART Cycle, it is contemplated that the individual will pay for each ART Cycle hence the potentially very stress-inducing burden of the cost of $10,000-$18,000 per ART Cycle. Subsequently, the individual is reimbursed a percentage of the cost of the ART Cycle. In such cases, the percentage is from 0.1% to 100% of the cost of the cycle or cycles. The reimbursement takes place after one, two, or more unsuccessful ART Cycles. A successful ART Cycle is defined as: zygote formation, embryo implantation, pregnancy through the first trimester, pregnancy through the second trimester, a live birth or a combination thereof.

### BRIEF DESCRIPTION OF THE DRAWINGS

FIG. 1 illustrates an ART reimbursement insurance method.

FIG. 2 illustrates one embodiment computer implemented system for carrying out the insurance method.

### DETAILED DESCRIPTION

While a few states have provisions for insurance providers to cover some types of infertility treatment, in general the limited and deficient benefits are exhausted in a short time and have restrictions and conditions attached. Currently, people who do not have coverage for infertility treatments and cannot afford to pay without assistance must apply for loans with very high interest rates, or take out home equity loans to obtain funds to pay for infertility treatments. Not only is the high cost of treating infertility prohibitive, but also the prohibitive nature of the costs generate significant stress for couples seeking infertility treatments; and this stress can cause relationship problems of some frustrated couples significantly decreasing the likelihood of successful ART.

Therefore, there is a need for methods and systems for providing and paying for insurance coverage of infertility treatments to reimburse the patient if a successful pregnancy or live birth is not achieved, thereby reducing or even eliminating the financial stress of the cost of ART and improving the likelihood of successful ART.

Thus, certain embodiments of the invention are to provide insurance coverage for ART cycles and other infertility treatments in a manner enabling individuals to pay an initial upfront cost to ensure partial or full reimbursement should a successful pregnancy or live birth not take place and to enjoy the peace of mind of knowing that they will not suffer the loss of their entire investment if ART is unsuccessful.

In the exemplary embodiments of the present invention, the invention is described with reference to figures. While specific details of the preferred exemplary embodiments are detailed, it is to be understood that the scope of the invention is not limited by such examples. It is also to be understood that, as used herein, the following terms are to have meanings as set out below:
1) ART (ART) Procedure—All treatments or procedures that involve surgically removing eggs from a woman's ovaries and combining the eggs with sperm to help a woman become pregnant.
2) ART (ART) Cycle—A process in which: (1) an ART Procedure is performed, (2) a woman has undergone ovarian stimulation or monitoring with the intent of having an ART Procedure, or (3) frozen embryos have been have been thawed with the intent of transferring them to a woman. An ART Cycle begins when a woman begins taking fertility drugs or having her ovaries monitored for follicle production or a frozen embryo or embryos is/are transferred to the woman.
3) Base Risk Factor (BRF)—The age group of the woman undergoing the ART cycle.
4) Base Risk Factor Variable (BRFV)—The IVF clinic success rate of live birth, after one ART cycle, based on the age group of the woman. As described herein, and for purposes of calculation, the Base Risk Factor (BRF) and Base Risk Factor Variable (BRFV, see below) are taken from data reported by the Centers for Disease Control (CDC). Specifically, the data is reported as a fresh embryo success rate and frozen embryo success rate and the fresh and frozen success rates are combined into a single success rate.
5) Risk Factor Variable (RFV)—The IVF clinic success rate of live birth, after three ART Cycles, based on the age group of the woman. In one embodiment, the RFV is calculated by averaging five years of the RFV and the age groups reported by the CDC and those averages are used to create a linear age trend, but those skilled in the art will recognize from this description that the RFV may also be calculated using other methods.
6) Adjusted Risk Factor Variable (ARFV)—Other factors that impact the success rate of the ART Cycle including but not limited to infertility diagnosis, previous live births with IVF, previous live births without IVF, stress, and other lifestyle choices. To illustrate, one Adjusted Risk Factor Variable, which is based on the success rate of live birth due to infertility diagnosis only. There are nine infertility diagnoses described herein and the ARFV is calculated as follows:
   A=success rate of the specific infertility diagnosis (in the embodiment described herein, the success rate is based on numbers reported by the Society of Assisted Reproductive Technology (SART) each year, per infertility diagnosis, and in the specific embodiment utilized, this rate is the average of 5 years (1+2+3+4+5/5).
   B=failed rate of the specific infertility diagnosis (1−A)
   C=probability of failure after 3 cycles [(1−A) to the third] Adjusted Risk Factor Variable=C/average failed IVF cycle based on all infertility factors combined.
The infertility diagnosis either debits or credits the Base Risk Factor Variable, and in one specific embodiment, those factors are set at 0.8, 0.9, 1.0, 1.2, 1.25, and/or 1.7.
7) Infertility Services—Other services or expenses related to the ART procedure such as pre-screening tests, prescription or over the counter medications, consultations, professional counseling and therapy and travel expenses.
8) Unsuccessful ART Cycle—the completion of an ART Cycle that fails to result in a live birth.
   Those skilled in the art will recognize from this description that other definitions of these terms may also be in implementing the present invention. To illustrate, in one embodiment, an Unsuccessful ART Cycle may be defined as the completion of an ART Cycle that results in a live birth but in which the neonate does not live more than 72 hours.

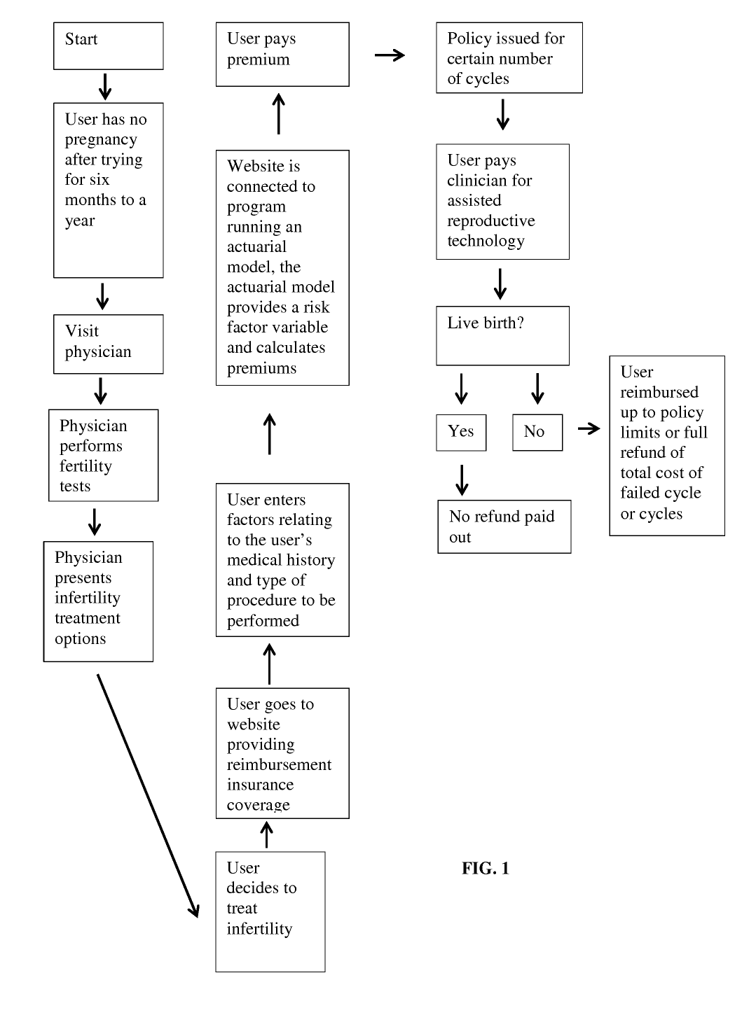

Referring to FIG. 1, in implementation, an ART insurance plan with reimbursement for reducing the stress of ART and increasing the likelihood of successful ART proceeds in the following way. First, a couple or woman who has been attempting to conceive naturally with no results will visit physician where tests will be performed to determine the medical reason for the infertility. After the tests are performed the couple or woman (if conceiving alone) will again visit with the doctor where fertility treatment options will be presented. If the couple or woman does not agree to an ART Procedure, then nothing more is done. If the couple or woman does agree to an ART Procedure, the couple or woman accesses a computer website with a graphical user interface. The computer website is hosted on a server and has a computer program tied to the graphical user interface which allows the woman or couple to enter in a number of factors. Typical factors that are input into the program hosted on the server include, but are not limited to the following: 1) age of the woman, 2) body mass index of the woman, 3) previous pregnancies, 4) previous miscarriages, 5) the clinic to be used, 6) whether the embryos will be fresh or frozen, 7) whether donor eggs will be used, 8) male infertility factors, 9) whether the woman's mother was given diethylstilbestrol during pregnancy, 10) previous ART cycles, 11) infertility diagnosis, 12) type of ART or infertility procedure, 13) smoking use, 14) drinking use and other health related and life-style issues, and 15) limit of insurance desired. Another input into the program hosted on the server may include a stress test that may be comprised, for instance, of a series of questions to elicit responses indicating raised stress and/or anxiety levels as known in the art. Other factors can also be used should they become apparent factors in the treatment of infertility.

Still further in implementation, after the woman or couple has entered the relevant factors into the computer program hosted on a server, the computer performs an actuarial model to generate an Infertility Risk Factor (IRF). The computer program hosted on a server then calculates one or more premiums which allow the woman or couple to pick the limit of insurance for ART or infertility services that is desired to be insured or reimbursed. The woman or couple then enter a credit or debit card number or checking account information into the computer program, which allows for payment of the upfront premium. It is contemplated herein that the actuarial model used generate an IRF is any actuarial model capable of doing so and an example of such a model for use in accordance with the method of the present invention is set out as follows:
1. Base Risk Factor (BRF)—Age group of women
2. Base Risk Factor Variable (BRFV)—The IVF clinic success rate of live birth based on Age group of women.
   (As described herein, and for purposes of calculation, the Base Risk Factor and Base Risk Factor Variable are taken from data such as the data reported by the CDC. In more detail, the data is reported as a fresh embryo success rate and frozen embryo success rate and the fresh and frozen success rates are combined into a single success rate).
3. Base Risk Factor Variable 5 year average:

(BRFV_{y1}+BRFV_{y2}+BRFV_{y3}+BRFV_{y4}+BRFV_{y5})/5=BRFV
4. Risk Factor Variable (RFV)—The IVF clinic success rate of live birth, after three ART Cycles, based on the age group of the woman.

[(100−BRFV)*(BRFV*0.01)+BRFV]=Base Risk Factor Variable after two cycles (BRFV₂)

[(100−BRFV₂)*(BRFV*0.01)+BRFV₂]=Base Risk Factor Variable after three cycles (BRFV₃)=Risk Factor Variable
Example: if the Base Risk Factor Variable five-year average is 40

(100−40)*(40*0.01)+40=64

(100−64)*(40*0.01)+64=78.4

Risk Factor Variable=78.4
5. In this particular embodiment, a linear age trend is utilized to give a Risk Factor Variable for each age. For example, if the Risk Factor Variable is 78.4 for the age group <35, it was trended as:
   30: 78.4+2
   31: 78.4+1
   32: 78.4
   33: 78.4−1
   34: 78.4−2
6. Price per $1,000 of coverage is based off of the Risk Factor Variable per specific age (linear trend), for example:
   Risk Factor Variable specific age: 78.4

1−(78.4)(0.01)

1—0.784=0.216

0.216*1,000=$216
$216 is the price per $1,000 of dollars of reimbursement coverage that is paid out on claims only, and in a particularly preferred embodiment, an expense, revenue, profit factor is added to produce a price per $1,000 of coverage. With an expense, revenue, and profit factor of, for instance, 23.5%,

216*23.5%=$266.76 per thousand dollars of coverage.
The $266.76 is then multiplied by the Adjusted Risk Factor Variable or Variables to generate the final Infertility Risk Factor.
7. Adjusted Risk Factor Variable—Other factors that impact the success rate of the ART Cycle include, but are not limited to, infertility diagnosis, previous live births with IVF, previous live births without IVF, and other lifestyle choices. Any one or more of these factors are capable of being used to calculate an Adjusted Risk Factor Variable. To illustrate, one Adjusted Risk Factor Variable, which is based on the success rate of live birth due to infertility diagnosis only, it is calculated as follows:
   A=success rate of the specific infertility diagnosis
   (in the embodiment described herein, the success rate is based on numbers reported by the Society of Assisted Reproductive Technology SART. each year, per infertility diagnosis, and in the specific embodiment utilized, this rate is the average of 5 years (1+2+3+4+5/5).
   B=failed rate of the specific infertility diagnosis (1−A)
   C=probability of failure after 3 cycles [(1−A) to the third]
   Adjusted Risk Factor Variable=C/average failed IVF cycle based on all infertility factors combined.
The nine infertility diagnoses with the corresponding Adjusted Risk Factor Variable are:
   1) Diminished Ovarian Reserve—1.7
   2) Endometriosis—0.9
   3) Female & Male Factors—1.0
   4) Male Factor—0.8
   5) Multiple Female Factors—1.25
   6) Other Factor—1.0
   7) Ovulatory Dysfunction—0.8
   8) Tubal Factor—1.0
   9) Uterine Factor—1.2

Example:
If the infertility diagnosis is a male factor, 0.8 is the Adjusted Risk Factor Variable.

$266.76*0.8=$213.40
$213.40 is the final Infertility Risk Factor.
For a couple wanting to purchase a $37,000 limit of insurance the total premium would be $7,896.

The woman or couple transmits the funds to the server accepting funds, for instance, with a credit card. In further embodiments, the woman or couple interacts with a financial institution or individual, hereinafter referred to as a financier, to acquire the funds for the reimbursement method. It is contemplated that the financier is a bank, a savings and loan, a brokerage firm, a corporation, a limited liability corporation, a limited liability partnership, a partnership or any other business entity. The financier is also a trustee controlling a trust or an executor of a will or any other individual. In such embodiments, the financier gives funds directly to the couple or woman, or the financier transmits the funds to the server accepting funds for the reimbursement method.

On average, implementation of a single ART Cycle, including medications, medical procedures and testing will cost $14,000 as of 2012 in United States dollars. The woman or couple pays this amount to the treating physician, clinic, pharmacy, etc. If the woman has a live birth after the first cycle, no payout from the reimbursement insurance takes place. Similarly, if the woman fails to have a live birth after the first cycle but has a live birth on the second cycle, no payout from the reimbursement insurance takes place. If no live birth is achieved after two or more cycles, depending on the number of cycles in the plan selected by the woman or couple, the reimbursement insurance pays up to the policy limits of the costs of the unsuccessful ART Cycles, including pre-screening and testing expenses, medications, medical procedures, professional counseling and/or therapy, and travel expenses. The present invention also contemplates the possibility of pricing the premium for the reimbursement insurance so that the payout is a percentage of reimbursement from the failed cycles, for instance, at 10%, 20%, 30%, 40%, 50%, 60%, 70%, 80%, 90% or 100% or some percentage between 1% and 100%.

Regarding the reimbursement, the reimbursement in certain embodiments, takes place after each failed cycle. Alternatively, the reimbursement takes place after the totality of failed cycles has been reached. Regarding cycles resulting in a successful pregnancy, the definition in terms of reimbursement insurance is any one of a number of outcomes. For example, a successful pregnancy is a positive pregnancy test result, implantation of the embryo within the uterus, pregnancy continuing after the first trimester, pregnancy continuing after the second trimester, or a successful live birth. The definition of a successful pregnancy impact the timing of the lump sum reimbursement or the per failed cycle reimbursement, depending on the option selected by the business or individual coordinating the insurance policy.

Regardless of the reimbursement option selected and paid for by the individual, the availability of reimbursement after a failed cycle provides a reduction in the financial risk involved in undergoing the ART procedure. That reduction of risk can be an important factor in increasing the likelihood of success of the ART procedure.

For the purpose of illustrating the reduction in financial risk, and therefore the stress reduction, provided by a reimbursement policy of the type described herein, the approximate average total cost of a three cycle attempt on is $37,000.00 United States dollars. In the case of a 75% reimbursement plan, a woman or couple would pay the $37,000.00 dollars for treatments. In the case of no live birth, the woman or couple would recover $27,750.00 of the total costs. Thus the maximum out of pocket expense for the woman or couple would be $16,483, which is the premium cost plus the 25% of $37,000.00. In the event that the woman or couple had a live birth, the maximum out of pocket expense would be $37,000.00 plus the premium cost, or $44,233.00.

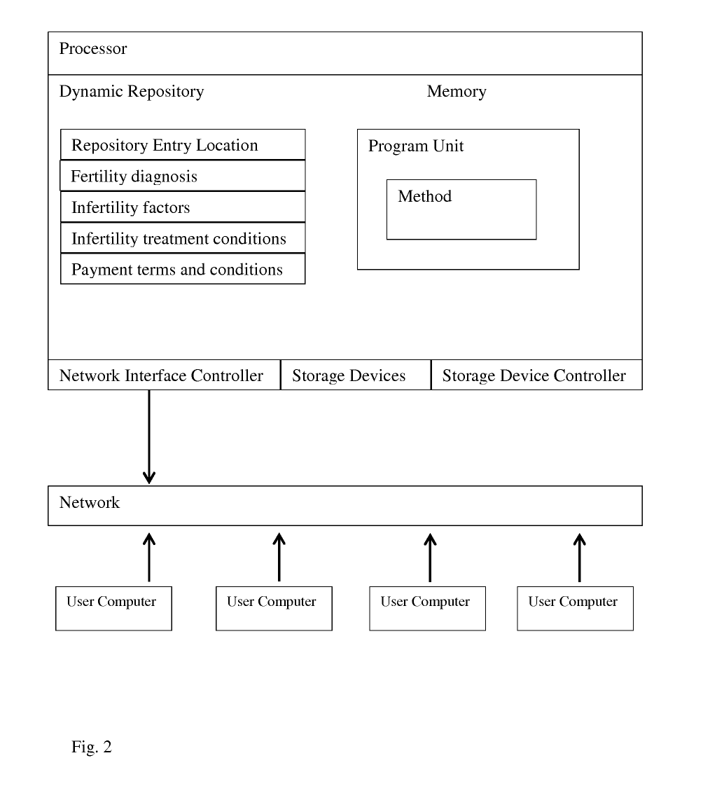

Referring to FIG. 2, a computer system for implementing the procedures and operations of the present method of increasing the likelihood of successful ART takes the form of computer executable program code, computer executable and computer readable media, and other hardware, firmware and software module, network, application and interface platforms upon which the method is carried out.

Still referring to FIG. 2, the system includes a computer processor and connected network interface controllers, input/output controllers, storage devices and input output devices such as network interface controllers, graphical user interface, an input/output controller, an output device, an input device, storage devices.

In FIG. 2, the network controller connects the processor to a network, where client side, server side, and user network devices reside and both interact and operate communicatively over the network. These devices include a plurality of end user computer systems, such as a personal computer used by a woman or couple wishing to purchase insurance. These devices also include network database and storage systems such as a database in which the above-described CDC data, SART data, and individual fertility clinic data are stored. The network can be a wide area network communications network, including an Internet or an extranet or the network can be a local area network, including an intranet.

Referring to FIG. 2, the input the input device is at least one of a mouse, a keyboard, a touch screen, a joystick, a thumbwheel, a light pen wand, an audio microphone or an electronic, a copier system or machine, a hard copier scanner system or machine, and/or a radio frequency scanning device (RFID).

Regarding the processor, the processor includes a memory. Residing in the memory are a program unit and a dynamic repository. Residing in the dynamic repository is a plurality of database entry locations. Thus, each database entry location can hold and/or store a plurality of information and/or data including, but not limited to factors such as 1) age of the woman, 2) body mass index of the woman, 3) previous pregnancies, 4) previous miscarriages, 5) the clinic to be used, 6) whether the embryos will be fresh or frozen, 7) whether donor eggs will be used, 8) male infertility factors, 9) whether the woman's mother was given diethylstilbestrol during pregnancy, 10) previous ART cycles, 11) infertility diagnosis, 12) type of ART procedure (also known as ART procedure), 13) smoking use, 14) drinking use, and 15) other health related issues and/or results of stress-assessment testing. Payment terms and conditions as well as contact information is also stored. These groups of information and data can be easily and programmatically accessed and exercised to provide various solutions to insurance related problems in regard to the provision of insurance coverage policies for ART Procedures.

The program has computer readable and computer executable media that itself contains a plurality of computer programs, algorithms, software applications, including operations and procedures of the insurance method encoded as computer readable and computer executable program code in the form of a program product. Still further, the program can have algorithms, software applications, including operations and procedures of the insurance method involving payment methods of a premium More specifically, the computer executable program computes the Infertility Risk Factor (IRF) from the data input by the woman or couple and that IRF is then utilized by the program to compute a premium, or price, for the insurance coverage policy coverage plan of the present invention. The financing options generated by the program involves such known procedures as providing the necessary inputs and executable code so that the woman or couple can enter a credit card number and other necessary information needed for payment from a personal computer. Alternatively, the computer program allows for future payment by financing, cash, check, or other valuable items to be delivered to an insurance agent or insurance company controlling the program.

In example embodiments, the insurance method is capable of being implemented in software, firmware or hardware or a combination of each. In certain embodiments, the insurance method is implemented in software as an executable program code which comprises an ordered listing of executable instructions for implementing logical functions and which is executed by a server.

In certain embodiments, the reimbursement insurance method is implemented in a server having a processor for executing software including software stored in the memory and in the program unit, including a program encoded as the reimbursement insurance method. The processor can be any custom made or commercially available, off-the-shelf processor, a central processing unit (CPU), one or more auxiliary processors, a semiconductor based microprocessor, in the form of a microchip or chip set, a macroprocessor or generally any device for executing software instructions. The memory and the dynamic repository and the storage device or devices, and the plurality of databases can include any one of or a combination of volatile memory elements, including random access memory (including RAM, DRAM, SRAM and/or SDRAM) and non-volatile memory elements including read only memory (including ROM, erasable programmable read only memory, electronically erasable programmable read only memory EEPROM, programmable read only memory PROM, and/or compact disc read only memory CD-ROM or FLASH memory) magnetic tape, disk, diskette, cartridge, cassette and/or optical memory. The memory can have an architecture where various components are situated remotely from one another, but can be accessed by the processor.

In a first exemplary embodiment, a woman or a couple enter in a website hosted connected to a server hosting the executable software. The server receives a signal from the user input device such as a personal computer, which activates and initiates the computer executable program code of the method. The method, upon activation, performs other operations from selection signals received in the processor from the input device, causing the method to be executed by the processor to perform operations and procedures including calling algorithms and applications executed to perform operations and sub operations of the method of providing one or more reimbursement insurance coverage policies for an ART Procedure. Thus, the processor receives automatically and electronically over the communications network a signal requesting initiation of the program code to register a woman or a couple for reimbursement insurance coverage policies for ART Procedures.

In a second exemplary embodiment, the executable software residing on the server is provided with the ability to call up and offer additional stress-reduction functions upon the receipt of certain selection signals from the input device. For instance, in response to a question as to the profession or employment of one or the other of the individual or partners undertaking ART, the server queries as to the number of hours worked by the individual or partners in an average work week and, depending on the response to that query, and on the assumption that the person(s) might be subjected to stress as a result of that employment or profession, offers counseling for workplace-induced stress. Similarly, in response to queries as to the lifestyle(s) of the individual(s), the server is programmed to be activated by certain selection signals that indicate the likelihood of tobacco use or use of other addictive substance(s) and then to offer smoking-cessation counseling and/or other behavior-modification therapies for the purpose of reducing stress on the woman and/or the fetus, thereby increasing the likelihood of successful ART.

What is claimed is:

1. A method of increasing the likelihood of success of Assisted Reproductive Technology (ART) by actively changing one or more factors influencing the success rate of ART by providing financial reimbursement for failed ART and infertility services for an individual using a computer and a server hosting a website, wherein the website includes a data entry interface and wherein the website is networked to a computer hosting a program that comprises an actuarial algorithm comprising the steps of:
i) entering into the data entry interface of the website responses to a list of queries intended to develop information as to infertility and health-related conditions that affect the infertility of the individual;
ii) transferring the data elicited in response to the queries as to the infertility and health-related conditions through the network to the server;
iii) generating an infertility risk factor product using the actuarial algorithm; and
iv) using the infertility risk factor product to produce one or more reimbursement options for one or more failed ART Cycles and infertility services having an insurance premium price quantified by the information entered into the computer by the individual for purchase by the individual, thereby decreasing the risk of financial loss due to a failed ART procedure.

2. The method of claim 1 wherein an insurance option for infertility treatment includes either one, two or more cycles of ART.

3. The method of claim 1 further comprising having the individual or a financier pay the premium for the expense reimbursement insurance for failed ART.

4. The method of claim 1 wherein the interface includes a payment interface.

5. The method of claim 4 wherein the individual pays a cost for each ART Cycle.

6. The method of claim 5 wherein a successful ART Cycle is defined as either:
zygote formation, embryo implantation, pregnancy through the first trimester, pregnancy through the second trimester, a live birth or a combination thereof.

7. The method of claim 6, wherein the insurance reimburses a percentage of the cost of failed ART Cycles and infertility services, including one or more of the expense of medications, medical procedures, medical testing, therapy, travel expenses, or a combination thereof.

8. The method of claim 7, wherein the individual is reimbursed after each unsuccessful ART Cycle.

9. The method of claim 7, wherein the individual is reimbursed after all unsuccessful ART Cycles.

10. The method of claim 1 wherein the factors influencing the success rate of the ART procedure include stress, anxiety, depression, overeating, fear, guilt, and shame.

11. The method of claim 10 additionally comprising the step of providing one or more of the following therapies to the individual for actively changing the factor influencing the success rate of the ART procedure: thought pattern counseling, nutritional counseling, self-image counseling, exercise and nutrition coaching, providing information as to the physiological and emotional changes inherent in pregnancy, lifestyle coaching, or counseling on the use of addictive substances

12. The method of claim 1 wherein the factors influencing the success rate of the ART procedure are actively influenced by one or more of the following: thought pattern counseling, nutritional counseling, self-image counseling, exercise and nutrition coaching, providing information as to the physiological and emotional changes inherent in pregnancy, lifestyle coaching, or counseling on the use of addictive substances.

13. The method of claim 1 wherein the insurance premium price is quantified by (a) defining a Base Risk Factor (BRF) representing a factor that influences the success rate of ART, (b) calculating a Base Risk Factor Variable at each BRF by averaging historical ART success rates at a selected clinic, (c) calculating a Risk Factor Variable by projecting the BRFV out over three ART cycles, (d) calculating the price per thousand dollars of reimbursement insurance by converting the Risk Factor Variable to a percentage representing the likelihood of a failed ART Cycle and multiplying by $1000.00, and (e) multiplying the price per thousand dollars of reimbursement insurance by an Adjusted Risk Factor Variable based on infertility diagnosis.

14. The method of claim 13 wherein the factor represented by the Base Risk Factor is the age group of the woman.
